(19) United States
(12) Patent Application Publication
(10) Pub. No.: US 2026/0119719 A1
(43) Pub. Date: Apr. 30, 2026

(54) MANAGING DATA CORROBORATED USING RELAXED CORROBORATION REQUIREMENTS

(71) Applicant: Dell Products L.P., Round Rock, TX (US)

(72) Inventors: OFIR EZRIELEV, Be'er Sheva (IL); TOMER KUSHNIR, Omer (IL); YEHIEL ZOHAR, Sderot (IL)

(21) Appl. No.: 18/928,708

(22) Filed: Oct. 28, 2024

(51) Int. Cl. G06F 21/64

(52) U.S. Cl. CPC G06F 21/64

(57) ABSTRACT

Methods and systems for managing data used to provide computer-implemented services are disclosed. To manage the data, a request for corroborated data may be obtained from a data consumer indicating a desired information content and corroboration requirements for the corroborated data. Based on the request, the corroborated data may be obtained which has the desired information content and may be obtained by a first data source. The corroborated data may be corroborated using at least second data obtained by a second data source adapted to measure a similar information content to the desired information content. The corroborated data may be corroborated using relaxed corroboration requirements due to at least a portion of the corroboration requirements being unable to be met. At least a portion of the corroborated data may be provided to the data consumer to facilitate provisioning of the computer-implemented services.

### FIELD

Embodiments disclosed herein relate generally to managing data used to provide computer-implemented services. More particularly, embodiments disclosed herein relate to systems and methods to manage data corroborated using relaxed corroboration requirements.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2D show diagrams illustrating data flows in accordance with an embodiment.

FIGS. 3A-3C show flow diagrams illustrating a method for managing data used to provide computer-implemented services in accordance with an embodiment.

FIG. 4 shows a diagram illustrating an example of obtaining corroborated data in accordance with an embodiment.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data used to provide computer-implemented services. The data may include any type and/or quantity of data obtained from any number of data sources, and a quality of the computer-implemented services may be impacted by a quality of the data. For example, inclusion of synthetic data (e.g., generated by a generative artificial intelligence (AI) model) in a dataset may reduce a quality of the dataset, thereby reducing a quality of computer-implemented services provided using the dataset.

For example, a data consumer may use the dataset to train an inference model (e.g., an artificial intelligence (AI) model) and/or the dataset may be used to generate prompts (e.g., ingest) for the inference model. Consequently, computer-implemented services provided using outputs from the inference model may be negatively impacted (e.g., may not meet needs of the data consumer and/or other downstream consumers).

To improve a likelihood of providing non-synthetic data to data consumers, non-synthetic data may be corroborated by performing a corroboration process using data from other data sources and may be provided to the data consumers upon receiving a request for corroborated data. The request may include a desired information content and corroboration requirements for the corroborated data. The corroboration requirements may include instructions, conditions, restrictions, and/or other requirements for performing the corroboration process, such as requirements for the data used to corroborate the corroborated data (e.g., a type of information content of the data, a timeframe in which the data was generated, a geographic location of the data source).

For example, first data to be corroborated may be obtained from a first data source having a first information content. To corroborate the first data, data usable to corroborate the first data which meets the corroboration requirements may be obtained. However, it may be determined that no data is available to corroborate the first data that meets the corroboration requirements. For example, a lookup process may be performed in a database using the first information content and/or other metadata for the first data as a key to identify entries in the database including data usable to corroborate the first data. The data from each of the identified entries may be compared to the corroboration requirements, and it may be concluded that no data from the identified entries meets the corroboration requirements.

Thus, in order to corroborate the first data, the corroboration requirements may be relaxed to obtain relaxed corroboration requirements. The relaxed corroboration requirements may include a lower standard for corroboration compared to the corroboration requirements. The corroboration requirements may be relaxed, for example, due to an urgency of need for the corroborated data indicated by the request. Relaxing the corroboration requirements may include modifying restrictions placed on the data usable to corroborate the first data. For example, modifying the restrictions may include: (i) updating a type of information content of the data (e.g., including a type of information content with a known relationship to the first information content and from which the first information content may be derived), (ii) extending a timeframe in which the data was collected (e.g., allowing past data to be used to corroborate the first data), (iii) extending a geographic location of the data source (e.g., allowing the data source to be further away than indicated by the corroboration requirements), and/or (iv) other modifications to the corroboration requirements.

Based on the relaxed corroboration requirements, second data may be obtained which is usable to corroborate the first data and meets the relaxed corroboration requirements. The second data may be obtained from a second data source and may have a second information content. The second data source may be a known non-synthetic data source (e.g., data collected by the second data source may be trusted as non-synthetic data) and may attempt to measure a similar information content as the first information content.

For example, the first data source may be a motion sensor device and the second data source may be a security camera positioned to collect video footage of an environment in which the first data source is positioned to collect motion data. Consequently, video footage from the second data source may be usable to corroborate data collected by the first data source (e.g., instances of motion capture).

During the corroboration process, it may be determined whether the first information content substantially matches the second information content (e.g., including any number of similarity analysis processes to compare the first information content and the second information content and based on any criteria for substantially matching). If it is determined that the first information content does not substantially match the second information content, it may be concluded that the second data does not corroborate the first data. If it is determined that the first information content substantially matches the second information content, it may be concluded that the second data corroborates the first data to obtain corroborated data. The corroborated data may be assigned a level of trust using a level of trust schema, which may include a rule set for assigning levels of trust to data based on degrees of corroboration of the data.

During the corroboration process, a corroboration result may be obtained. The corroboration result may include an indication of whether the first information content substantially matches the second information content, the level of trust for the corroborated data, and/or metadata indicating limits on use of the corroborated data. For example, the metadata may include (i) identifiers for the data sources and/or entities which manage the data sources used to obtain the first data and/or the second data, (ii) data indicating a timeframe over which any data used in the corroboration process was collected, and/or (iii) data indicating relaxed corroboration requirements were used for performing the corroboration process, and/or (iv) other data. If the corroboration result indicates that the first information content substantially matches the second information content, it may be concluded that the first data is corroborated. At least a portion of the corroborated data may then be provided to the data consumer, and may be used to facilitate provisioning of the computer-implemented services (e.g., used for inference model training).

Thus, embodiments disclosed herein may address, among other technical problems, the technical challenge of providing data to a data consumer that meets the expectations of the data consumer and is usable to facilitate provisioning of computer-implemented services. By performing a corroboration process for the data using relaxed corroboration requirements, a likelihood of obtaining other data from other data sources usable to corroborate the data may be increased. Corroborated data may then be provided to the data consumer with an acceptable level of trust that the data is not synthetic. In doing so, a likelihood of providing computer-implemented services in a desired manner may be increased.

In an embodiment, a method for managing data used to provide computer-implemented services is disclosed. The method may include: obtaining a request for corroborated data from a data consumer, the request indicating a desired information content and corroboration requirements for the corroborated data; obtaining, based on the request, the corroborated data, the corroborated data: having the desired information content and being corroborated using at least second data obtained by a second data source, the second data source being adapted to measure a similar information content to the desired information content which the first data source is adapted to measure; being corroborated using relaxed corroboration requirements due to at least a portion of the corroboration requirements being unable to be met, the relaxed corroboration requirements being acceptable to the data consumer; and providing at least a portion of the corroborated data to the data consumer to facilitate provisioning of the computer-implemented services.

The relaxed corroboration requirements may include a lower standard for corroboration compared to the corroboration requirements.

The corroboration requirements may include at least one type of requirements selected from a list of types of requirements consisting of: a type of information content of the second data; a timeframe in which the second data was generated; and a geographic location of the second data source.

The request for corroborated data may indicate an urgency of need for the corroborated data.

The method may also include: obtaining first data from the first data source to be corroborated and the corroboration requirements, the first data having a first information content; making a determination that no data is available that is usable to corroborate the first data that meets the corroboration requirements; based on the determination: relaxing the corroboration requirements to obtain the relaxed corroboration requirements; obtaining, based on the relaxed corroboration requirements, the second data, the second data meeting the relaxed corroboration requirements and having a second information content; performing, using at least the first data and the second data, and based on the relaxed corroboration requirements, a corroboration process to obtain a corroboration result; and concluding, based on the corroboration result, that first data is corroborated.

Performing the corroboration process may include: making a determination regarding whether the first information content substantially matches the second information content; in a first instance of the determination in which the first information content substantially matches the second information content: concluding that the second data corroborates the first data to obtain the corroborated data; assigning, based on at least the second data and a level of trust schema, a level of trust for the corroborated data; and in a second instance of the determination in which the first information content does not substantially match the second information content: concluding that the second data does not corroborate the first data.

The corroboration result may include an indication of whether the first information content substantially matches the second information content, the level of trust for the corroborated data, and metadata indicating limits on use of the corroborated data.

The level of trust schema may include a rule set for assigning levels of trust to data based on degrees of corroboration of the data.

The degrees of corroboration may be based on a quantity of aspects of the data which are corroborated.

The aspects may include at least one type of aspect selected from a list of types of aspects consisting of: a portion of a third information content of the data; a timestamp of the data; and a geographic location where the data was collected.

The degrees of corroboration may be based on a quantity of data sources which corroborate the data, and the rule set may ascribe higher levels of trust with higher degrees of corroboration.

The corroboration requirements may indicate that the data usable to corroborate the first data is only available from data sources that are unable to provide the data at a time of corroboration of the corroborated data, and the second data source may not meet the corroboration requirements.

The corroborated data may be deemed to be corroborated based on the second data source: having provided an information content of data generated by the second data source substantially matching the desired information content; and not supplying synthetic data.

The corroborated data may not be synthetic data.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

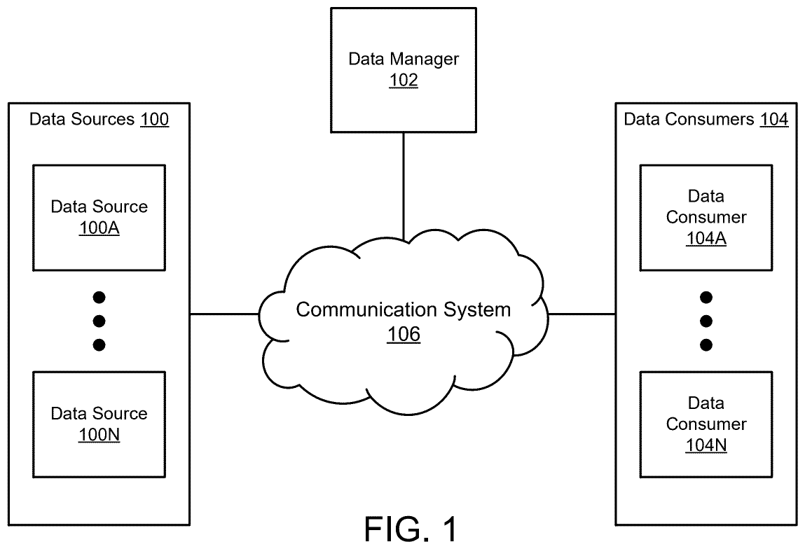

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include data storage services, instant messaging services, database services, data generation services, and/or any other type of service that may be implemented with a computing device. Provision of the computer-implemented services may be facilitated, at least in part, using data obtained from any number of data sources.

To facilitate the provision of the computer-implemented services, a data consumer may obtain data (e.g., from a data source, from a third-party data manager). A quality of the computer-implemented services may be impacted by a quality of the data used to provide the computer-implemented services. For example, inclusion of synthetic data (e.g., data generated by a generative artificial intelligence (AI) model) in a dataset may reduce a quality of the dataset (e.g., by not reflecting real-world conditions), thereby reducing a quality of the computer-implemented services provided using the dataset. Inclusion of synthetic data in the dataset may also reduce a trustworthiness of the dataset and/or the computer-implemented services provided using the dataset. Thus, synthetic data may have a reduced likelihood of meeting the needs of the data consumer and/or a downstream consumer of the computer-implemented services.

In general, embodiments disclosed herein may provide methods, systems, and/or devices for increasing a likelihood of providing non-synthetic data to a data consumer. To do so, non-synthetic data may be corroborated during a corroboration process using relaxed corroboration requirements when corroboration requirements for the non-synthetic data are unable to be met. By corroborating data using the relaxed corroboration requirements, data may be corroborated as non-synthetic using available data with an acceptable level of trust that the data is not synthetic. The corroborated data may then be provided to the data consumer to facilitate provisioning of computer-implemented services (e.g., to train inference models). In doing so, a likelihood of providing computer-implemented services in a desired manner may be increased.

To do so, a request for corroborated data may be obtained from the data consumer indicating a desired information content and corroboration requirements for the corroborated data. To obtain the corroborated data, first data may be obtained from a first data source having a first information content. It may be determined that no data is sufficient to corroborate the first data (e.g., no data is available that is usable to corroborate the first data that meets the corroboration requirements, data from data sources which meet the corroboration requirements may be unavailable at the time of corroboration). Based on the determination, the corroboration requirements may be relaxed to obtain the relaxed corroboration requirements. The corroboration requirements may be relaxed, for example, to facilitate corroboration due to an urgency of need for the corroborated data indicated by the request. The relaxed corroboration requirements may include a lower standard for corroboration compared to the corroboration requirements.

Based on the relaxed corroboration requirements, second data usable to corroborate the first data which meets the relaxed corroboration requirements may be obtained from a second data source and having a second information content. The second data source may attempt to measure a similar information content as the first information content, and may be trusted as non-synthetic (e.g., the second data source may be known to collect measurements reflective of real-world conditions). Therefore, the second data may be usable to corroborate the first data as non-synthetic.

Using at least the first data and the second data, and based on the relaxed corroboration requirements, a corroboration process may be performed to determine whether the first information content substantially matches the second information content. If the first information content does not substantially match the second information content, it may be concluded that the second data does not corroborate the first data. If the first information content substantially matches the second information content, it may be concluded that the second data corroborates the first data to obtain corroborated data.

The corroborated data may be assigned, based on at least the second data and the level of trust schema, a level of trust for the corroborated data. The level of trust schema may include a rule set for assigning levels of trust to data based on degrees of corroboration of the data. The degrees of corroboration of the data may be based on a quantity of aspects of the data which are corroborated (e.g., a portion of a third information content of the data, a timestamp for the data, a geographic location where the data was collected) and/or a quantity of data sources which corroborate the data. The rule set may assign higher levels of trust with higher degrees of corroboration.

During the corroboration process, a corroboration result may be obtained which may include an indication of whether the first information content substantially matches the second information content, the level of trust, and/or metadata indicating limits on use of the corroborated data (e.g., identifiers for the data sources and/or entities which manage the data sources used to obtain the first data and/or the second data, data indicating a timeframe over which any data used in the corroboration process was collected, data indicating relaxed corroboration requirements were used for performing the corroboration process). If the corroboration result indicates the first information content substantially matches the second information content, it may be concluded that the first data is corroborated (e.g., the corroborated data), and the corroborated data may be provided to the data consumer. The corroborated data may then be used to facilitate provisioning of computer-implemented services.

By doing so, embodiments disclosed herein may improve a likelihood that data consumers obtain corroborated data which is not synthetic and is usable to facilitate provisioning of computer-implemented services. By corroborating non-synthetic data using relaxed corroboration requirements, a likelihood of corroborating the data as non-synthetic may be increased. Once corroborated, a level of trust may be assigned to the corroborated data which may be used to determine whether a trustworthiness of the data meets the expectations of the data consumers. In addition, resources (e.g., computing resources, time resources, cognitive resources of an SME) may be conserved that may otherwise be allocated to attempting to retroactively determine whether previously generated data is synthetic. Consequently, use of the corroborated data may increase a likelihood of providing the computer-implemented services in a desired manner.

To provide the above noted functionality, the system of FIG. 1 may include data sources 100, data manager 102, data consumers 104, and communication system 106. Each of these components is discussed below.

Data sources 100 may include any number of data sources (e.g., 100A-100N). Each data source of data sources 100 may include hardware and/or software components configured to obtain data, store data, provide data to other entities, and/or to perform any other task to facilitate provisioning of computer-implemented services. All, or a portion of, data sources 100 may provide data used to facilitate provisioning of the computer-implemented services to various computing devices operably connected to data sources 100. Different data sources may facilitate the provisioning of similar and/or different computer-implemented services.

Data sources 100 may include any type of devices adapted to collect, generate, and/or otherwise obtain data which is not synthetic (e.g., not generated by a generative AI model). For example, data sources 100 may include (i) sensors (e.g., motion sensors, temperature sensors, pressure sensors, infrared sensors), (ii) cameras (e.g., security cameras, traffic cameras, smartphone cameras), (iii) location tracking (e.g., global positioning system (GPS)) devices (e.g., GPS vehicle trackers, asset trackers, GPS-enabled smartphones), (iv) smart devices (e.g., smart streetlights, smart cars), (v) audio recording devices (e.g., microphones), (vi) connectivity devices (e.g., cell towers, Wi-Fi routers), and/or (vii) other types of data sources. Each data source of data sources 100 may be adapted to obtain any type of data, such as numerical data, audio, images, video, text, etc.

The data obtained by data sources 100 may be provided to data manager 102, which may provide data management services for data sources 100 and/or consumers of the data (e.g., data consumers 104). Data manager 102 may include any number and/or type of devices such as data processing systems. To provide the data management services, data manager 102 may: (i) obtain data (e.g., from data sources 100), (ii) process the data (e.g., fill data gaps, transform the data, extract values from the data), (iii) perform corroboration procedures to obtain corroborated data and/or levels of trust for the corroborated data (e.g., determine whether second data corroborates first data, assign the levels of trust to the corroborated data), (iv) store the corroborated data in a corroborated data database and/or other storage architecture, and/or (v) perform other tasks.

As part of performing the corroboration procedures, data manager 102 may: (i) obtain a request for corroborated data from a data consumer indicating a desired information content and/or corroboration requirements for the corroborated data, (ii) obtain the corroborated data based on the request (e.g., reading the corroborated data from a corroborated data database and/or other storage architectures, generating the corroborated data based on the request), (iii) provide at least a portion of the corroborated data to the data consumers, and/or (iv) perform other tasks.

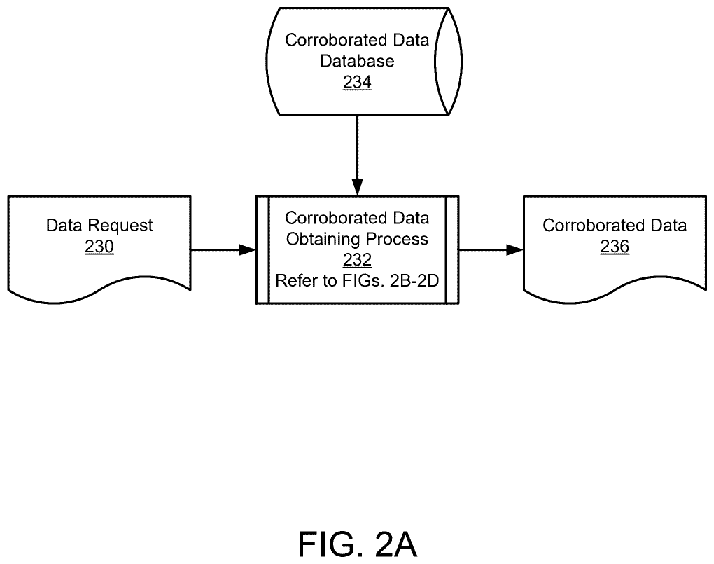

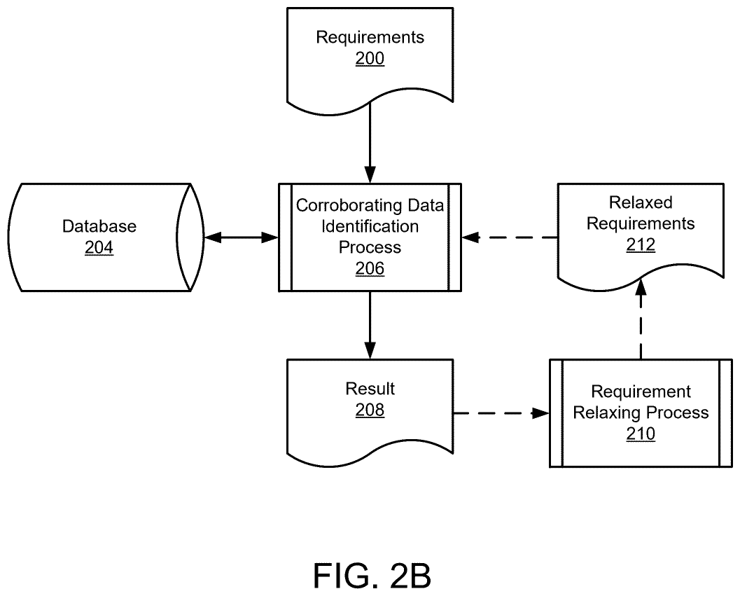

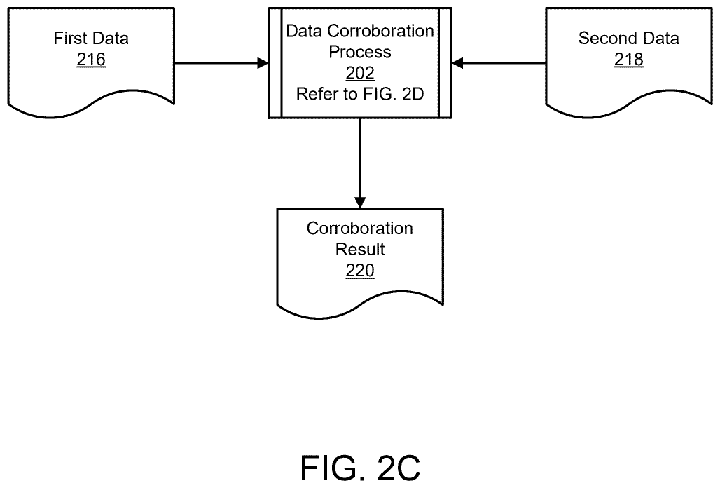

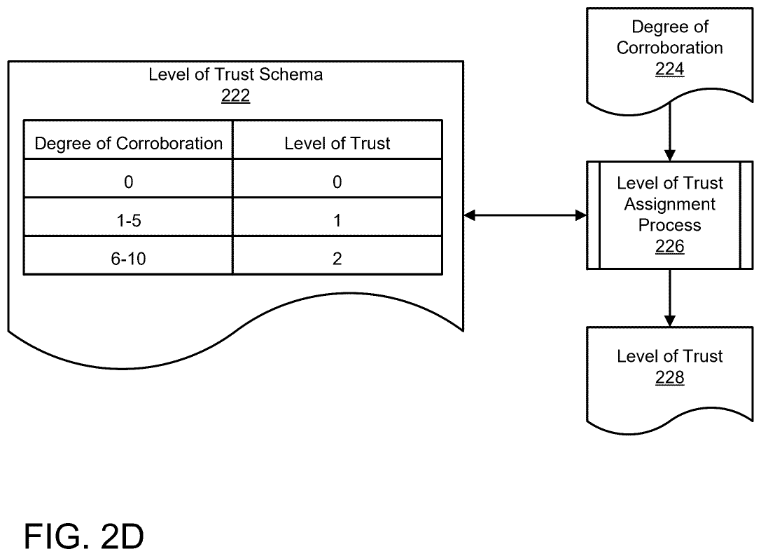

To generate the corroborated data, data manager 102 may: (i) obtain first data to be corroborated from a first data source which has a first information content, and/or (ii) determine whether data is available that is usable to corroborate the first data that meets the corroboration requirements. If no data is available that is usable to corroborate the first data and meets the corroboration requirements, data manager 102 may: (i) relax the corroboration requirements to obtain relaxed corroboration requirements (e.g., modifying restrictions placed on the data usable to corroborate the first data), (ii) obtain second data from a second data source which has a second information content and meets the relaxed corroboration requirements for corroboration of the first data, (iii) perform a corroboration process using at least the first data and the second data and based on the relaxed corroboration requirements to obtain a corroboration result, the corroboration result including metadata for the corroborated data including data indicating relaxed corroboration requirements were used for performing the corroboration process), (iv) conclude, based on the corroboration result, that the first data is corroborated, (v) store the corroborated data and/or at least a portion of the corroboration result (e.g., the corroborated data may be tagged as corroborated using relaxed corroboration requirements) in the corroborated data database and/or other storage architecture, and/or (vi) perform other tasks. The second data may be corroborated data (e.g., obtained from a corroborated data database) that was corroborated using a higher standard for corroboration than the relaxed corroboration requirements for corroborating the first data. Thus, the second data may be trustworthy for use in corroborating the first data as non-synthetic data. Refer to the description of FIG. 2B for additional details regarding relaxing the corroboration requirements.

During the corroboration process, data manager 102 may compare a first information content of the first data to a second information content of the second data using any type and/or quantity of corroboration algorithms. The information contents may be compared to determine whether the first information content substantially matches the second information content (e.g., based on any criteria for matching determined by a SME, data consumer, and/or any other entity). If the first information content does not substantially match the second information content, it may be concluded that the second data does not corroborate the first data. If the first information content does substantially match the second information content, it may be concluded that the second data corroborates the first data to obtain corroborated data.

Any number of other data sources may be used to corroborate the first data, and each data source may corroborate at least one aspect of the first data. The at least one aspect may include: (i) a portion of a third information content of the first data, (ii) a timestamp for the first data, (iii) a geographic location where the first data was collected, and/or (iv) other aspects. Refer to the description of FIGS. 2B-2C for additional details regarding performing corroboration procedures.

Upon obtaining corroborated data, data manager 102 may assign a level of trust to the corroborated data. The level of trust may indicate a trustworthiness that the corroborated data is not synthetic data. To assign the level of trust, data manager 102 may: (i) obtain a level of trust schema, the level of trust schema including a rule set for assigning levels of trust to data based on degrees of corroboration of the data (e.g., a quantity of data sources which corroborate the data and/or a quantity of aspects of the data which are corroborated), and/or (ii) identify, based on the level of trust schema and the degrees of corroboration of the data, the level of trust for the data. The level of trust schema may include a rule set which assigns higher levels of trust with higher degrees of corroboration (e.g., a larger quantity of data sources which corroborate the data and/or a larger quantity of aspects of the data which are corroborated indicate the data is more trustworthy). Refer to the description of FIG. 2D for additional details regarding assigning a level of trust to corroborated data.

As a result of performing the corroboration procedure, a corroboration result may be obtained. The corroboration result may include: (i) an indication of whether the first information content substantially matches the second information content, (ii) the level of trust for the corroborated data, (iii) metadata (e.g., the metadata included in the corroboration result and/or other metadata) indicating limits on use of the corroborated data (e.g., identifiers for the data sources and/or entities which manage the data sources used to obtain the first data and/or the second data, data indicating a timeframe over which any data used in the corroboration process was collected, data indicating relaxed corroboration requirements were used for performing the corroboration process), and/or (iv) other information. Based on the corroboration result, it may be concluded that the first data is corroborated (e.g., if the corroboration result indicates the first information content substantially matches the second information content).

The corroborated data, the level of trust, metadata, and/or any portion of the data used to corroborate the corroborated data may be stored in a corroborated data database and/or other type of storage architecture. The corroborated data database may include an immutable ledger including entries that are cryptographically verifiable (e.g., a blockchain). By doing so, data verifying a trustworthiness that the corroborated data is not synthetic data may be stored with the corroborated data and/or used to prove corroboration to consumers of the corroborated data (e.g., data consumers 104).

Data consumers 104 may provide and/or consume all, or a portion of, the computer-implemented services. Data consumers 104 may include any number of data consumers (e.g., 100A-100N) and may include, for example, businesses, individuals, and/or devices (e.g., data processing systems) that may obtain the corroborated data and/or other information based on the corroborated data to facilitate provisioning of the computer-implemented services. For example, data consumers 104 may use the corroborated data to train any number of inference models to generate responses when provided with ingest data. The responses may be used as a computer-implemented service and/or to provide the computer-implemented services to downstream consumers of the computer-implemented services.

Each data consumer of data consumers 104 may have different requirements for trustworthiness of the corroborated data. For example, a first level of trust threshold for data consumer 104A may require the corroborated data to have a first level of trust that the data is not synthetic, while a second level of trust threshold for data consumer 104B may require the corroborated data to have a second level of trust that the data is not synthetic (e.g., the first level of trust may be a higher level of trust than the second level of trust). When providing a request for corroborated data (e.g., to data manager 102), data consumers 104 may include a desired level of trust for the corroborated data (e.g., as a part of the corroboration requirements), a desired information content of the corroborated data, and/or other corroboration requirements (e.g., a type of information content of the second data, a timeframe in which the second data was generated, a geographic location of the second data source). Refer to the description of FIG. 2A for additional details regarding requesting corroborated data.

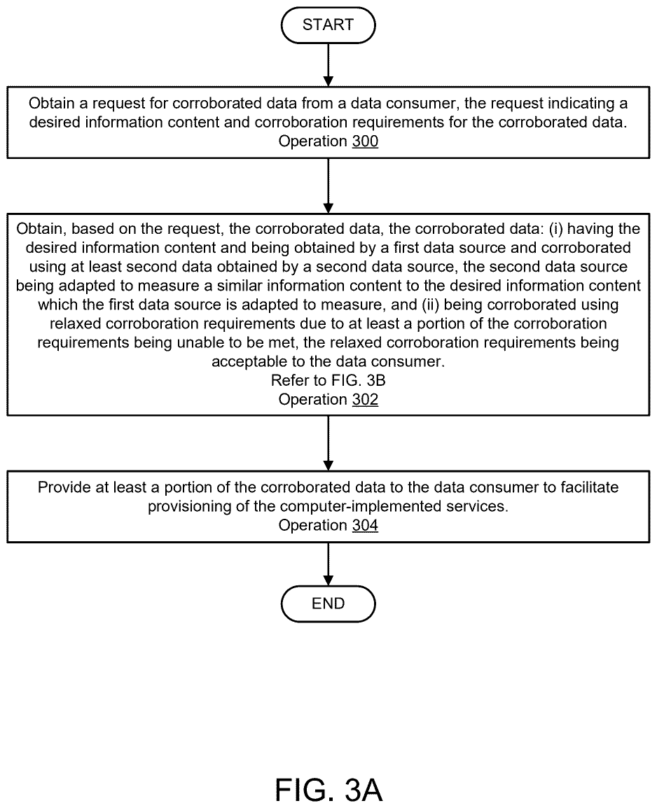

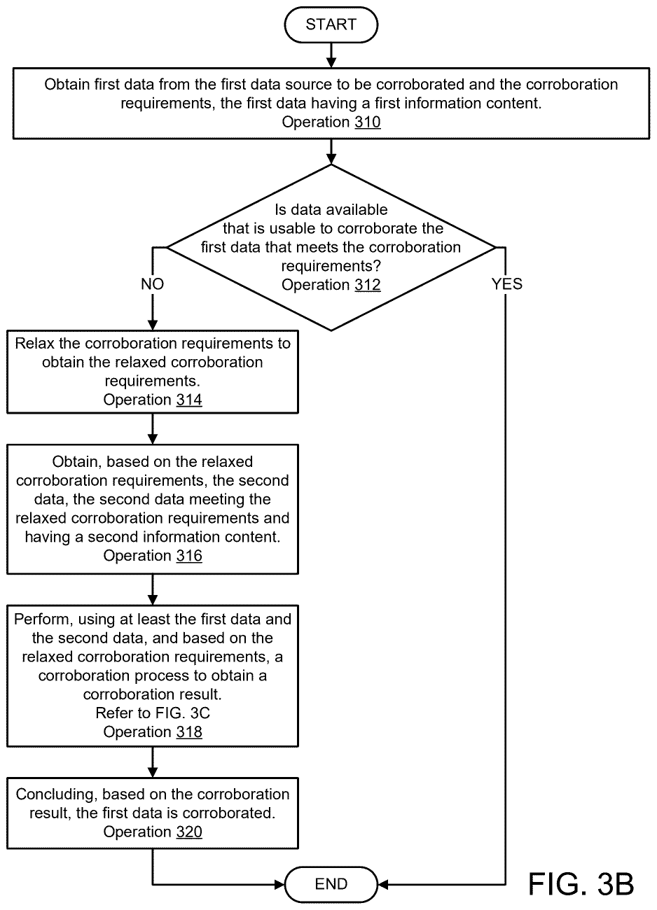

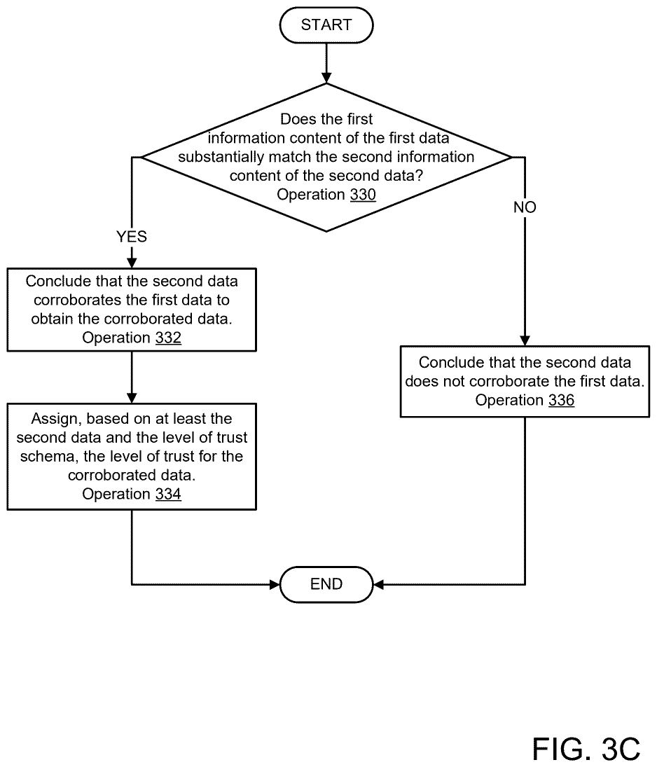

When providing their functionality, any of (and/or components thereof) data sources 100, data manager 102, and/or data consumers 104 may perform all, or a portion, of the actions and methods illustrated in FIGS. 2A-3C.

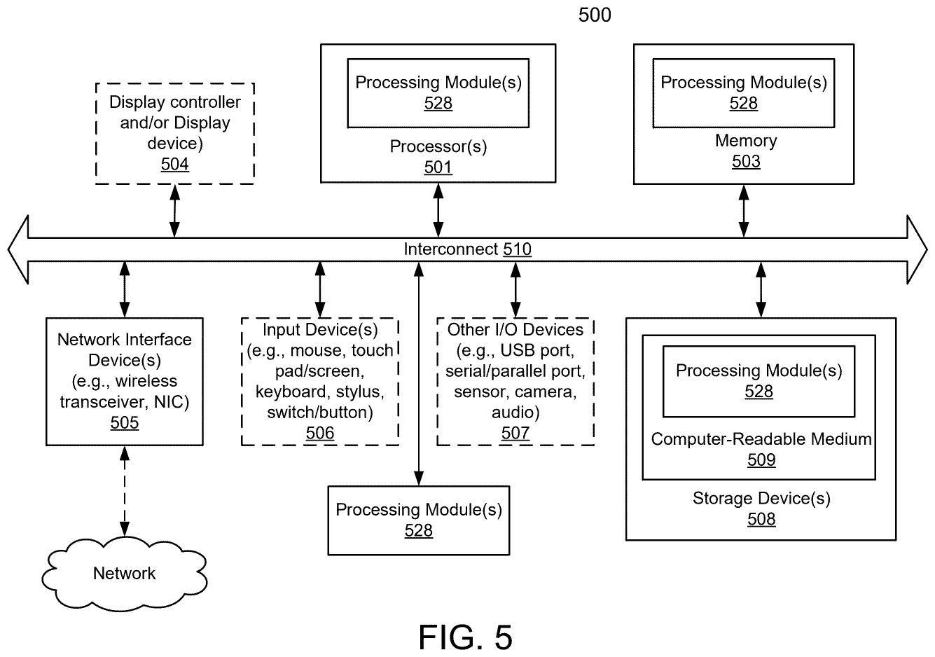

Any of (and/or components thereof) data sources 100, data manager 102, and/or data consumers 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 5.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

The system described in FIG. 1 may be used to manage data to improve an availability and/or quality of computer-implemented services provided to downstream consumers of the computer-implemented services. The following processes described in FIGS. 2A-2D may be performed by the system in FIG. 1 when providing this functionality.

To further clarify embodiments disclosed herein, data flow diagrams in accordance with an embodiment are shown in FIGS. 2A-2D. In these diagrams, flows of data and processing of data are illustrated using different sets of shapes. A first set of shapes (e.g., 230, 236, etc.) is used to represent data structures, a second set of shapes (e.g., 232, 206, etc.) is used to represent processes performed using and/or that generate data, and a third set of shapes (e.g., 234, 204) is used to represent large scale data structures such as databases.

Turning to FIG. 2A, a first data flow diagram in accordance with an embodiment is shown. The first data flow diagram may illustrate data used in and data processing performed in providing corroborated data (e.g., corroborated data 236) to a data consumer upon obtaining a request for the corroborated data (e.g., data request 230). The corroborated data may be corroborated using relaxed corroboration requirements. Refer to FIG. 2B for additional details regarding relaxed corroboration requirements.

To provide the corroborated data to the data consumer, corroborated data obtaining process 232 may be performed. During corroborated data obtaining process 232, data request 230 may be obtained. Data request 230 may include a request for the corroborated data from the data consumer, and may: (i) indicate a desired information content of the corroborated data, (ii) indicate corroboration requirements for the corroborated data, and/or (iii) include a request for other data. The corroboration requirements may include: (i) a type of information content of the data used to corroborate the corroborated data, (ii) a timeframe in which the data used to corroborate the corroborated data was generated, (iii) a geographic location of the data source of the data used to corroborate the corroborated data, (iv) a level of trust for the corroborated data, and/or (v) other requirements. Refer to FIG. 2B for additional details regarding corroboration requirements and refer to FIG. 2D for additional details regarding levels of trust. Data request 230 may be obtained, for example, by an entity responsible for maintaining corroborated data database 234 (e.g., data manager 102, not shown).

Data request 230 may indicate an urgency of need for the corroborated data. The urgency of need for the corroborated data may be quantified and/or represented in any manner usable to indicate a degree of urgency for obtaining the corroborated data. For example, the urgency of need may be represented on a numerical scale (e.g., a scale of 1-5, where 5 represents the highest urgency of need), using letters that correspond to degrees of urgency, and/or by providing a timeframe in which the corroborated data is to be obtained (e.g., within 5 minutes). Certain representations of the urgency of need may trigger allowance of relaxed corroboration requirements while performing corroboration processes.

For example, data request 230 may indicate a request from a data center (e.g., a data consumer) for corroborated data in response to a complaint that a station is overheating, resulting in a reduced performance efficiency on February 12^{th}. The data center may need to take immediate action to prevent equipment damage in the event that the station is determined to be overheating, thus, data request 230 may indicate an urgency of need for the corroborated data (e.g., the urgency of need may be a 10 on a scale of 1-10, where 10 represents the highest urgency of need). The request may include a desired information content of the corroborated data (e.g., a temperature of the station) and corroboration requirements such as a timeframe in which data used to corroborate the temperature of the station was generated (e.g., between 8 a.m. and 5 p.m. on February 12^{th}) and a geographic location of the data source which obtained the data used to corroborate the temperature of the station (e.g., the station at the data center).

Based on the request, corroborated data 236 may be obtained during corroborated data obtaining process 232. Obtaining corroborated data 236 may include: (i) performing a lookup process in a corroborated data database (e.g., corroborated data database 234) and/or other type of storage architecture used to store corroborated data, and/or (ii) generating the corroborated data by performing a corroboration process based on data request 230.

Corroborated data database 234 may include an immutable ledger including entries that are cryptographically verifiable (e.g., a blockchain). For example, corroborated data database 234 may be implemented as a blockchain where each entry includes metadata blocks chained together to form an immutable (e.g., non-editable) data structure. The metadata blocks may be added to the blockchain using any method (e.g., consensus, proof of work, proof of interest) and may include: (i) the corroborated data and/or a hash of the corroborated data, (ii) the level of trust and/or a hash of the level of trust, (iii) the data used to corroborate the corroborated data and/or a hash of the data used to corroborate the corroborated data, (iv) entity identifiers indicating entities which added the metadata blocks, (v) authentication data usable to validate that the entities which added the metadata blocks are trusted entities (e.g., cryptographically verifiable signatures), and/or (vi) other data.

Modification of an entry of corroborated data database 234 may be restricted to trusted entities. To determine whether an entry in corroborated data database 234 is trusted (e.g., was not modified by an unauthorized entity), authentication data for each metadata block may be used to validate the entry. Validating the entry may include: (i) comparing the entity identifiers to those of trusted entities to attempt to find a match (e.g., lack of a match may indicate that the corresponding entry is not to be trusted), (ii) using the authentication data in each respective metadata block to validate that the metadata block was, in fact, added by the entity identified by the entity identifier (e.g., using a public key of a public private key pair maintained by the entity to validate that the signature was added by the entity). For example, a unilateral or bilateral authentication process may be performed using the authentication data (or through a third, intermediate entity such as an authentication service). If all the metadata blocks are indicated to be added by a trusted entity and can be authenticated, then the entry may be trusted. Otherwise, the entry may not be trusted.

While described with respect to corroborated data database 234 including an immutable ledger, it will be appreciated that corroborated data may be stored in any type of database and/or other storage architecture without departing from embodiments disclosed herein.

To obtain corroborated data 236 from corroborated data database 234, the lookup process may be performed in corroborated data database 234 using the desired information content as a key for a lookup table included in corroborated data database 234 to identify entries which include the desired information content. Data included in the identified entries may be compared to the corroboration requirements (e.g., included in data request 230) to identify data which meets the corroboration requirements. If data request 230 indicates a sufficiently high urgency of need for the corroborated data (e.g., based on any criteria and/or quantification for degrees of urgency) and/or no data is able to be identified which meets the corroboration requirements, the corroboration requirements may be relaxed (e.g., due to at least a portion of the corroboration requirements being unable to be met), and a second lookup process may be performed to identify data which meets the relaxed corroboration requirements. The relaxed corroboration requirements may be acceptable to the data consumer and may include a lower standard for corroboration compared to the corroboration requirements. Refer to the description of FIG. 2B for additional details regarding relaxing the corroboration requirements.

Upon relaxing the corroboration requirements, at least one entry may be identified which meets the relaxed corroboration requirements. From one of the at least one entry, corroborated data 236 may be selected which: (i) has the desired information content, and/or (ii) was obtained by a first data source and corroborated using at least second data obtained by a second data source, the second data source being adapted to measure a similar information content to the desired information content which the first data source is adapted to measure.

Continuing with the above example, based on the request from the data center for corroborated data including a temperature (e.g., the desired information content) of the station at the data center between 8 a.m. and 5 p.m. on February 12^{th} (e.g., the corroboration requirements), a lookup process may be performed in corroborated data database 234 to identify entries including the desired information content which meet the corroboration requirements. However, it may be determined that at least a portion of the corroboration requirements are unable to be met (e.g., no entries which meet the corroboration requirements may be identified during the lookup process). To obtain the corroborated data, the corroboration requirements may be relaxed to obtain relaxed corroboration requirements (e.g., the corroboration standard may be lowered). The relaxed corroboration requirements may include an expanded acceptable timeframe for the data used to corroborate the corroborated data (e.g., between 6 a.m. and 9 p.m. on February 11^{th}-13^{th}), and may retain the geographic location requirement. A second lookup process may be performed using the relaxed corroboration requirements, and an entry may be identified which meets the relaxed corroboration requirements. Corroborated data 236 may then be selected from the identified entry.

Corroborated data 236 may also be obtained by dynamically generating corroborated data 236 upon obtaining a request from the data consumer. To dynamically generate corroborated data 236, a corroboration process may be performed using the relaxed corroboration requirements. Refer to the description of FIGS. 2B-2C for additional details regarding performing the corroboration process.

Upon obtaining corroborated data 236, a response to data request 230 may be provided to the data consumer to facilitate provisioning of computer-implemented services. The response may include: (i) at least a portion of corroborated data 236, (ii) the corresponding level of trust, (iii) data used to corroborate corroborated data 236, and/or (iv) other data, such as any other metadata blocks included in the entry in corroborated data database 234 which includes corroborated data 236.

If an entry is unable to be identified which includes the desired information content and/or meets the relaxed corroboration requirements, data manager 102 may: (i) further relax the corroboration requirements and perform a third lookup process using the further relaxed corroboration requirements, (ii) provide an error message to the data consumer, the error message indicating that acceptable corroborated data was unable to be identified from corroborated data database 234, (iii) provide a counter proposal to the data consumer, and/or (iv) perform other actions. For example, the counter proposal may include corroborated data from corroborated data database 234 which has the desired information content, but does not meet the relaxed corroboration requirements.

Turning to FIG. 2B, a second data flow diagram in accordance with an embodiment is shown. The second data flow diagram may illustrate data used in and data processing performed in identifying data usable to corroborate first data based on relaxed corroboration requirements (e.g., relaxed requirements 212) and obtaining a result (e.g., result 208). The processes described in FIG. 2B may be performed as part of performing corroborated data obtaining process 232 shown in FIG. 2A.

During the corroboration procedure, requirements 200 may be obtained from a request for corroborated data from a data consumer (e.g., data request 230, refer to FIG. 2A). Requirements 200 may include corroboration requirements for data used to corroborate first data obtained by a first data source and having a first information content. Requirements 200 may include corroboration requirements such as instructions, conditions, restrictions, and/or other requirements for the data used to corroborate the first data (e.g., a type of information content of the data, a timeframe in which the data was generated, a geographic location of the data source). Refer to the description of FIG. 2A for additional details regarding the corroboration requirements.

During corroborating data identification process 206, the data usable to corroborate the first data may be identified based on requirements 200. To do so, first data may be obtained from a database (e.g., database 204), and/or may be included in the request for corroborated data from the data consumer (e.g., the first data may be provided for corroboration). The first data may include any type and/or quantity of data obtained from a first data source (not shown) which is not synthetic data (e.g., not generated by a generative AI model). For example, the first data may include measurements reflective of real-world conditions obtained from sensors, cameras, smart devices, etc. and may include data such as numerical data, audio, images, video, text, etc.

Metadata for the first data may also be obtained during corroborating data identification process 206. The metadata for the first data may include: (i) any number and/or type of information contents for the first data, (ii) a GPS location for the first data source, (iii) ambient environment measurements (e.g., temperature measurements) for the first data source, (iv) timestamps for measurements collected by the first data source, (v) cellular and/or other types of connection information for the first data source, and/or (vi) other types of metadata.

The information contents may include information extracted from the data, such as: (i) entities depicted by an image and/or video (e.g., people, objects, geographic markers), (ii) quantities and/or other types of numerical information (e.g., a number of times an event occurred in a video recording), (iii) a number of objects depicted by an image, (iv) statistical characterizations of a dataset, (v) sounds captured by a video and/or audio recording (e.g., conversations, animals, background noises such as a train sound), and/or (vi) other information.

For example, a request may be obtained from an agriculture business for corroborated data including an amount of pesticide sprayed on a field (e.g., the desired information content). Based on the request, first data may be obtained from a database including concentrations of pesticide sprayed on the field in July (e.g., the first information content) measured by a chemical sensor in the field (e.g., the first data source). The request may include corroboration requirements, including a timeframe in which data used to corroborate the first data was collected (e.g., July), and a geographic location of the data source which obtained the data used to corroborate the first data (e.g., the field).

As part of performing corroborating data identification process 206, requirements 200 may be used to identify data from any number of data sources which may be usable to corroborate the first data. Data may be usable to corroborate the first data by meeting requirements 200, which may include: (i) having a desired type of information content (e.g., similar to a type of information content of the first data), (ii) being generated during a desired timeframe, (iii) being obtained by a data source in a desired geographic location, and/or (iv) meeting other corroboration requirements.

To identify the data usable to attempt to corroborate the first data, a lookup process may be performed in database 204 (e.g., using a lookup table included in database 204) using the first information content and/or other metadata from the first data as a key for the lookup table to identify entries in database 204, and data from the identified entries may be compared to requirements 200 to determine whether any of data from the identified entries meets requirements 200. Database 204 may include a database used to store any type and/or quantity of data obtained from other data sources (e.g., data sources which are not the first data source) which are not synthetic data and may also include metadata for the data. The data stored in database 204 may include data obtained from sensors, cameras, smart devices, etc. and may include data such as numerical data, audio, images, video, text, etc. While described with respect to searching database 204 for data usable to corroborate the first data, it may be appreciated that the data usable to corroborate the first data may be identified via other methods such as providing data requests to various data sources.

Returning to the above example, the lookup process may be performed using the amount of pesticide as a key to identify entries in database 204, and data from the identified entries may be compared to requirements 200 (e.g., data that was obtained by a data source located in the field and that was obtained in July) to determine whether any of the data from the identified entries meet requirements 200.

However, requirements 200 may indicate that the data usable to corroborate the first data is only available from data sources that are unable to provide the data at a time of corroboration of the corroborated data. For example, during the lookup process third data from a third data source may meet requirements 200 to corroborate the first data. However, the third data source may be powered off, inoperable, and/or otherwise unable to provide the third data at the time of corroborating the first data. Thus, the third data may not be available from database 204 when the lookup process is performed. As a result, it may be determined that no data is available that is usable to corroborate the first data that meets requirements 200.

Continuing with the above example, a lookup process may be performed to identify data usable to corroborate the first data obtained by the chemical sensor which meets the corroboration requirements (e.g., data that was obtained by a data source located in the field and that was obtained in July). Based on the corroboration requirements, it may be determined that the data usable to corroborate the first data is only available from a drone (e.g., the third data source) that sprayed the pesticide in July. However, it may be determined that the drone data is unavailable at the time of corroboration of the first data. Therefore, it may be determined that no data is available to corroborate the first data which meets the corroboration requirements.

During corroborating data identification process 206, result 208 may be obtained. Result 208 may include: (i) a data structure indicating whether data usable to corroborate the first data was identified, (ii) the data usable to corroborate the first data, (iii) metadata for the data usable to corroborate the first data (e.g., a time the data was collected, a geographic location of the data source, an information content of the data), and/or (iv) other information. For example, result 208 may indicate that no data is available to corroborate the first data that meets requirements 200.

If result 208 indicates that data is available to corroborate the first data that meets requirements 200, the data may be used to corroborate the first data. If result 208 indicates that no data is available to corroborate the first data that meets requirements 200, requirement relaxing process 210 may be performed. Refer to the description of FIGS. 2C-2D for additional details regarding corroborating the first data.

During requirement relaxing process 210, at least a portion of requirements 200 used to identify data usable to corroborate the first data may be modified, updated, and/or otherwise relaxed to obtain relaxed requirements 212. Relaxing requirements 200 may include: (i) updating a type of information content of the data (e.g., including a type of information content with a known relationship to the first information content), (ii) extending a timeframe in which the data was collected (e.g., allowing past data to be used to corroborate the first data), (iii) extending a geographic location of the data source (e.g., allowing the data source to be further away than indicated by requirements 200), and/or (iv) other modifications to requirements 200. In doing so, relaxed requirements 212 may be obtained which include a lower standard for corroboration compared to requirements 200.

Relaxed requirements 212 may be determined by the data consumer and/or another entity based on stated and/or anticipated needs of the data consumer. In a first example, acceptable relaxed corroboration requirements may be provided by the data consumer as a part of the request for corroborated data. In a second example, the acceptable relaxed corroboration requirements may be determined by an entity responsible for managing a corroborated data database (e.g., data manager 102, not shown) upon populating the corroborated data database. The corroborated data may be stored in the corroborated data database including metadata indicating that the corroborated data was corroborated using relaxed corroboration requirements.

For example, relaxing requirements 200 may include updating the type of information content of the data to a type of information content that does not directly indicate the first information content but may be used to derive the first information content using the known relationship (e.g., between the updated information content and the first information content). For example, the first information content may include a total distance traveled by a car. To corroborate the first data, the type of information content included in requirements 200 (e.g., the total distance traveled by the car) may be updated to include the speed of the car over a duration of time as part of relaxed requirements 212. Because the updated type of information content (e.g., speed over time) has a known relationship to the first information content (e.g., distance traveled), the updated type of information content may be used to derive the first information content during corroboration.

While portions of requirements 200 may be relaxed, other portions of requirements 200 may be retained and included in relaxed requirements 212. For example, requirements 200 may include a first requirement and a second requirement. The first requirement may be relaxed to obtain an updated first requirement. As a result, relaxed requirements 212 may include the updated first requirement and the second requirement.

Continuing with the above example, the corroboration requirements for corroborating the first data obtained by the chemical sensor (e.g., data that was obtained by a data source located in the field and that was obtained in July) may be relaxed upon making the determination that no data is available which meets the corroboration requirements. Relaxing the corroboration requirements may include extending the acceptable timeframe in which the data was collected. For example, the relaxed corroboration requirements may include data that was obtained by a data source located in the field and that was obtained in June. Data obtained in June may be considered acceptable to corroborate the first data because it may be known (e.g., by the agriculture business) that a similar amount of pesticide was sprayed in June and July.

Using relaxed requirements 212, corroborating data identification process 206 may be repeated to identify data from database 204 usable to corroborate the first data which meets relaxed requirements 212. Based on relaxed requirements 212, second data from a second data source may be obtained which meets relaxed requirements 212. The second data may have a second information content and the second data source may attempt to measure a similar information content as the first information content (e.g., information extracted from the second data may include information similar to the first information content). The second data source may be trusted to provide non-synthetic data (e.g., the second data may include measurements of real-world conditions).

For example, the second data source may include any type of data source which obtains any type of data, and may not be limited to a type of data source as the first data source and/or a type of data as the first data. For example, the first data may include video of a building entrance obtained by a video camera, and the second data may include sensor data measured by a motion sensor on a door to the building. The motion sensor data may indicate a number of times the door opened, which may be used to corroborate the video showing people entering the building. The video camera and the motion sensor may not be controlled by the same entity, thereby increasing a trust in using the sensor data to corroborate the video.

The second data source may meet relaxed requirements 212 (e.g., may be located in a first geographic location which meets a relaxed requirement of relaxed requirements 212) and may not meet requirements 200 (e.g., may not be located in a second geographic location which meets a requirement of requirements 200). Thus, the second data may meet relaxed requirements 212 but may not meet requirements 200.

Upon obtaining the second data usable to corroborate the first data, a corroboration process may be performed using at least the first data and the second data and based on the relaxed corroboration requirements. For additional details regarding performing the corroboration process, refer to the description of FIGS. 2C-2D.

Continuing with the above example, second data usable to corroborate the first data obtained by the chemical sensor which meets the relaxed corroboration requirements (e.g., data that was obtained by a data source located in the field and that was obtained in June) may be obtained. For example, the second data may include an amount of pesticide sprayed by the drone in June. The second data may then be used to corroborate the first data.

If data which meets relaxed requirements 212 is not available, relaxed requirements 212 may undergo a second cycle of requirement relaxing process 210 to obtain further relaxed requirements. Cycles of relaxing requirements may continue until data usable to corroborate the first data is identified and/or until a predetermined number of cycles are complete, at which point it may be determined that the first data is not able to be corroborated using available data.

Turning to FIG. 2C, a third data flow diagram in accordance with an embodiment is shown. The third data flow diagram may illustrate data used in and data processing performed in performing a corroboration process using at least first data and second data and based on relaxed corroboration requirements to obtain a corroboration result (e.g., corroboration result 220).

To obtain corroboration result 220, data corroboration process 202 may be performed using at least first data 216 and second data 218. First data 216 may be obtained by a first data source and may include first data to be corroborated, metadata for the first data, and/or other data. Based on the relaxed corroboration requirements (not shown), second data 218 may be obtained. Second data 218 may meet the relaxed corroboration requirements and may be obtained by a second data source. Second data 218 may include second data usable to corroborate the first data, metadata for the second data, and/or other data. Refer to the description of FIG. 2A for additional details regarding the first data and the second data.

During data corroboration process 202, a corroboration algorithm may be used to compare a first information content of first data 216 to a second information content of second data 218. The corroboration algorithm may be included in a request for corroborated data from the data consumer, and may include any calculations, data transformations, and/or other manipulations of data usable to compare the first information content and the second information content. For example, the first information content may include any number of discrete temperature measurements collected over a duration of time and the second information content may include an average temperature measurement for the duration of time. During data corroboration process 202, the corroboration algorithm may be used to calculate an average temperature measurement for the discrete temperature measurements included in first data 216 to compare to the second information content.

For example, the first data may include a 3-hour video of a traffic intersection obtained by a traffic camera, and the first data may have a first information content including a total number of people on a sidewalk depicted by the video over 3 hours (e.g., 60 people).

Second data from a cell tower may be obtained to corroborate the first data, the second data having a second information content including an average number of cellular devices that were connected to the cell tower per hour (e.g., the second information content) at the time and geographic location the video was obtained by the traffic camera (e.g., 22 devices). To compare the first information content to the second information content, the corroboration algorithm may be used to obtain an average number of people on the sidewalk per hour depicted by the video (e.g., 20 people).

During data corroboration process 202, it may be determined whether second data 218 corroborates first data 216. Second data 218 may corroborate first data 216 when the first information content of first data 216 substantially matches the second information content of second data 218. Performing the corroboration process may include performing any number and/or type of analysis and/or verification processes using any criteria for substantially matching (e.g., determined by a SME, the data consumer, and/or any other entity). The criteria for substantially matching may be included, for example, in the request for corroborated data from the data consumer.

For example, performing the corroboration process may include comparing a quantity of the first information content to a quantity of the second information content to obtain a difference. The quantity of the first information content may include, for example, a number of instances of a motion sensor being activated and the quantity of the second information content may include a number of people seen entering a building. The quantity of the first information content and the quantity of the second information content may be obtained over a same duration of time and, therefore, the number of instances of the motion sensor being activated may indicate people entering the building. Therefore, the difference may indicate an extent to which the motion sensor was activated by the people entering the building. The difference may be compared to the criteria for substantially matching to determine whether the first information content substantially matches the second information content.

For example, criteria for determining whether the first information content substantially matches the second information content may (i) permit a 10% difference (e.g., at least 90% of the first information content and the second information content matches), (ii) permit a 5% difference (e.g., at least 95% of the first information content and the second information content matches), (iii) permit a 2% difference (e.g., at least 98% of the first information content and the second information content matches), and/or (iv) include other criteria to be deemed substantially matching.

It will be appreciated that the criteria for determining whether the first information content substantially matches the second information content may vary based on a type and/or other characteristic of the information content. For example, a quantity of the first information content and the second information content may be permitted to differ by 10%, while other types of information contents, such as geographic location coordinates, may be permitted to differ by 2%.

Continuing with the above example, the first information content (e.g., 20 people per hour recorded on the sidewalk) may be compared to the second information content (e.g., 22 devices per hour connected to the cell phone tower) to obtain a difference. For example, the difference may indicate that the information contents differ by 9.5%. The difference may be compared to criteria for substantially matching determined by a consumer of the first data and/or provided by the first data source (e.g., as part of requirements 200), which may indicate the information contents may differ by 10% to be considered substantially matching. Therefore, in this example, it may be determined that the first information content and the second information content substantially match.

If it is determined that the first information content substantially matches the second information content, it may be concluded that second data 218 corroborates first data 216 to obtain corroborated data. The corroborated data may be deemed to be corroborated based on the second data source: (i) having provided the second information content of the second data generated by the second data source that substantially matches the first information content, (ii) not supplying synthetic data, and/or (iii) other criteria. Continuing with the above example, it may be concluded, based on the first information content substantially matching the second information content, that the cell tower data corroborates the first data obtained by the traffic camera, and the first data may be treated as corroborated data.

If it is determined that the first information content does not substantially match the second information content, it may be concluded that the second data does not corroborate the first data. If the second data does not corroborate the first data, other data from other data sources (e.g., from database 204, not shown) may be evaluated to determine whether any of the other corroborates the first data and/or the first data may be rejected for use as corroborated data.

Performing data corroboration process 202 may include obtaining a degree of corroboration for the corroborated data and/or assigning a level of trust for the corroborated data based on at least the second data and a level of trust schema. Refer to the description of FIG. 2D for additional details regarding obtaining the degree of corroboration and/or the level of trust for the corroborated data.

As a result of performing data corroboration process 202, corroboration result 220 may be obtained. Corroboration result 220 may include: (i) an indication of whether the first information content substantially matches the second information content, (ii) the level of trust for the corroborated data, (iii) metadata indicating limits on use of the corroborated data, and/or (iv) other information. For example, corroboration result 220 may include a “yes” or “no” answer indicating whether the first information content substantially matches the second information content and/or may include any quantities obtained during data corroboration process 202, including the difference. If corroboration result 220 indicates that the first information content substantially matches the second information content, it may be concluded that the first data is corroborated.

The metadata included in corroboration result 220 may include copies and/or hashes of data used to perform and/or obtained during performance of data corroboration process 202, including: (i) hashes of software code used to perform data corroboration process 202, (ii) a hash of the corroboration algorithm, (iv) a hash of first data 216 and/or second data 218, and/or (iv) other information.

The metadata may also include data usable to determine restrictions and/or other parameters which may impact an ability to use the corroborated data by the data consumer and/or to corroborate other data at future point in time. For example, the metadata may include: (i) identifiers for the data sources and/or entities which manage the data sources used to obtain first data 216 and/or second data 218, (ii) data indicating a timeframe over which any data used in the corroboration process was collected, (iii) data indicating relaxed corroboration requirements were used for performing the corroboration process, and/or (iv) other data.

In a first example, the metadata for the corroborated data may include identifiers indicating a first entity manages the first data source and a second entity manages the second data source. It may be determined that the corroborated data may not be used to corroborate other data obtained by any data sources managed by the first entity and/or the second entity.

In a second example, the metadata for the corroborated data may include a timeframe over which first data 216 and second data 218 was collected. The corroborated data may include, for example, data including an amount of pesticide sprayed on a field. The metadata may indicate the first data and the second data used to obtain the corroborated data was obtained over a summer growing season. Based on the metadata, it may be determined that the data is not usable to corroborate data regarding an amount of pesticide sprayed on the field in a winter season.

Turning to FIG. 2D, a fourth data flow diagram in accordance with an embodiment is shown. The fourth data flow diagram may illustrate data used in and data processing performed in obtaining a level of trust (e.g., level of trust 228) for corroborated data using a level of trust schema (e.g., level of trust schema 222) based on degree of corroboration 224. The processes illustrated in FIG. 2D may be performed as part of performing data corroboration process 202 shown in FIG. 2C.

To obtain level of trust 228 for data, degree of corroboration 224 may be obtained. Degree of corroboration 224 may be based on any number of factors, and may be represented as a numerical scale (e.g., from 0 to 10 with higher numbers indicating higher trustworthiness) and/or via any other means.

For example, degree of corroboration 224 may be based on: (i) a quantity of data sources which corroborate the data, (ii) a quantity of aspects of the data which are corroborated, and/or (iii) other criteria. The aspects may include any type of aspect, characteristic, and/or metadata of the data, which may include: (i) a portion of a third information content of the data, (ii) a timestamp for the data, (iii) a geographic location where the data was collected, and/or (iii) other information.

For example, to determine a quantity of data sources which corroborate first data, information content of data from any number of additional data sources may be compared to a first information content of the first data. For example, the first information content of the first data may be compared to a second information content of second data from a second data source and a third information content of third data from a third data source. If it is determined that the first information content substantially matches the second information content and the third information content, it may be concluded that the second data source and the third data source corroborate the first data. In this example, two data sources (e.g., the second data source and the third data source) may corroborate the first data.

For example, a number of people on a sidewalk indicated by first data obtained by a traffic camera (e.g., a first information content) may be compared to a number of people on the sidewalk indicated by second data obtained by a smartphone camera and third data obtained by a security camera. If it is determined that the number of people on the sidewalk indicated by first data substantially matches the number of people on the sidewalk indicated by the second data and the third data, it may be concluded that the second data and the third data corroborate the first data, and, therefore, two data sources corroborate the first data.

To determine the quantity of aspects of the first data which are corroborated, the aspects of the first data may be compared to aspects of each data source that corroborates the first data. For example, a first aspect of the first data may include the first information content and a second aspect of the first data may include a third information content which may be corroborated using any number of data sources. Other aspects of the first data (e.g., a timestamp for the first data, a geographic location where the first data was collected) may also be corroborated.

Continuing with the above example, the first data obtained by the traffic camera may include a third information content including a license plate number for a car. The license plate number indicated by the first data may be compared to a license plate number indicated by fourth data obtained from a drone (e.g., a fourth data source). If it is determined that the license plate numbers substantially match, it may be concluded that the drone corroborates the second aspect of the first data (e.g., the third information content). The first data may also include a GPS location for the traffic camera used to obtain the first data, which may be compared to a GPS location for the drone. If it is determined that the GPS location for the traffic camera and the GPS location for the drone substantially match, it may be concluded that the drone corroborates a third aspect of the first data. Thus, two aspects of the first data may be corroborated by the drone. Similar methods may be performed for each corroborating data source to determine a number of aspects of the first data that are corroborated by each corroborating data source.

Degree of corroboration 224 may be assigned to corroborated data based on any formula and/or schema that takes into account information including: (i) the quantity of data sources which corroborate the corroborated data, (ii) the quantity of aspects of the corroborated data which are corroborated, and/or (iii) other information. For example, if it is concluded that two aspects of the first data are corroborated by two data sources (e.g., each of the two data sources separately corroborates both of the two aspects), the first data may be assigned a degree of corroboration of four. In this example, a schema for assigning degrees of corroboration may include a numerical scale where each aspect of data that is corroborated by each corroborating data source increases the degree of corroboration by one starting from a degree of corroboration of zero. Degrees of corroboration may be assigned based on any other schema without departing from embodiments disclosed herein.

To obtain level of trust 228, level of trust assignment process 226 may be performed. During level of trust assignment process 226, degree of corroboration 224 may be used to search level of trust schema 222 for a level of trust associated with degree of corroboration 224. Level of trust schema 222 may include a rule set for assigning levels of trust to data based on degrees of corroboration of the data. The rule set may, for example, assign higher levels of trust with higher degrees of corroboration (e.g., data with a higher degree of corroboration may be deemed more trustworthy than data with a lower degree of corroboration).

Level of trust schema 222 may be organized as a table, including a series of columns and rows as shown in FIG. 2D, with a first column including degrees of corroboration and a second column including levels of trust corresponding to the degrees of corroboration indicated by the first column. The degrees of corroboration included in the first column may be represented in any manner including, for example, numbers, letters, characters, and/or any combination thereof. The levels of trust included in the second column may be represented in any manner including, for example, numbers, letters, characters, and/or any combination thereof.

A level of trust for data may indicate to a consumer of the data a trustworthiness that the data is not synthetic based on the degree of corroboration. For example, a higher (e.g., based on a numerical scale between 0-10 where 0 indicates the lowest degree of corroboration and 10 indicates the highest degree of corroboration) degree of corroboration may indicate that more data sources corroborated the data and/or more aspects of the data were able to be corroborated when compared to data assigned a lower degree of corroboration, which may increase a data consumer's ability to trust that the data was not generated by a generative AI model, simulation, and/or other synthetic method. Conversely, a lower degree of corroboration may indicate that fewer data sources corroborated the data and/or fewer aspects of the data were able to be corroborated when compared to data assigned a higher degree of corroboration, which may indicate to the data consumer that there may be an increased likelihood that the data was generated by a generative AI model and/or a decreased likelihood that the data is reflective of real-world conditions.

For example, degree of corroboration 224 may include a degree of corroboration of five for corroborated data. Using the degree of corroboration and level of trust schema 222, level of trust 228 may be obtained, which may include a level of trust of 1 for the corroborated data as shown in level of trust schema 222. In this example, levels of trust may be assigned based on a scale of 0-2 with higher numbers being associated with higher degrees of corroboration and, therefore, higher trustworthiness.

While the level of trust schema shown in FIG. 2D is shown as associating specific degrees of corroboration with levels of trust, it will be appreciated that any degree of corroboration and/or range of degrees of corroboration may be associated with any level of trust without departing from embodiments disclosed herein.

Upon obtaining level of trust 228, the corroborated data, level of trust 228, and/or any other information may be stored in a corroborated data database and/or other storage architecture. Refer to the description of FIG. 2A for additional details regarding the corroborated data database.

Thus, by implementing the data flows shown in FIGS. 2A-2D, a system in accordance with embodiments disclosed herein may be used to provide corroborated data to a data consumer which was corroborated using relaxed corroboration requirements in a manner that is acceptable to the data consumer. By corroborating data using other data from other data sources (e.g., second data from a second data source), a resource cost (e.g., computational resources, time resources, cognitive resources) of verifying data is not synthetic and/or training inference models using synthetic data may be reduced. Consequently, resources may be allocated to providing computer-implemented services and a likelihood that the computer-implemented services may be provided as desired to downstream consumers may be increased.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1-2D may perform various methods to manage data used to provide computer-implemented services. FIGS. 3A-3C illustrate a method that may be performed by the components of the system of FIGS. 1-2D. In the diagrams discussed below and shown in FIGS. 3A-3C, any of the operations may be repeated, performed in different orders, and/or performed in parallel with or in a partially overlapping in time manner with other operations.

Turning to FIG. 3A, a first flow diagram illustrating a method for managing data used to provide computer-implemented services in accordance with an embodiment is shown. The method may be performed, for example, by any of the components of the system of FIG. 1, and/or any other entity without departing from embodiments disclosed herein.

At operation 300, a request for corroborated data may be obtained from a data consumer, the request indicating a desired information content and corroboration requirements for the corroborated data. Obtaining the request for the corroborated data may include: (i) receiving the request from the data consumer, (ii) receiving the request from another entity (e.g., an intermediate entity), (iii) reading the request from storage, and/or (iv) other methods.

At operation 302, the corroborated data may be obtained based on the request. The corroborated data may: (i) have the desired information content and be obtained by a first data source and corroborated using at least second data obtained from a second data source, the second data source being adapted to measure a similar information content to the desired information content that the first data source is adapted to measure, and/or (ii) be corroborated using relaxed corroboration requirements due to at least a portion of the corroboration requirements being unable to be met, the relaxed corroboration requirements being acceptable to the data consumer.

Obtaining the corroborated data may include: (i) reading the corroborated data from storage, (ii) generating the corroborated data, and/or (iii) other methods.

Reading the corroborated data from storage may include: (i) performing a lookup in a corroborated data database and/or other storage architecture using the desired information content as a key to identify entries including the desired information content, (ii) selecting, from one of the at least one entry, the corroborated data which both has the desired information content and meets the relaxed corroboration requirements, and/or (iii) other methods.

Performing the lookup may include: (i) searching entries in the corroborated data database and/or other storage architecture to identify the at least one entry which includes the desired information content (e.g., using the desired information content as key phrases for the search), (ii) providing the desired information content to another entity and receiving the at least one entry which includes the desired information content in response, and/or (iii) other methods.

Selecting the corroborated data may include: (i) obtaining data and/or metadata (e.g., a time the data was obtained by a data source, a geographic location of the data source, an information content of the data) included in the at least one entry, (ii) comparing the data and/or metadata for the at least one entry to the relaxed corroboration requirements to determine whether the at least one entry meets the corroboration requirements, (iii) if the at least one entry meets the corroboration requirements: selecting the corroborated data from the at least one entry, and/or (iv) other methods.

Generating the corroborated data may include: (i) obtaining first data from a first data source to be corroborated and the corroboration requirements, the first data having a first information content, (ii) making a determination that no data is available that is usable to corroborate the first data that meets the corroboration requirements, (iii) relaxing the corroboration requirements to obtain the relaxed corroboration requirements, (iv) obtaining, based on the relaxed corroboration requirements, the second data, the second data meeting the relaxed corroboration requirements and having a second information content, (v) performing, using at least the first data and the second data, and based on the relaxed corroboration requirements, a corroboration process to obtain a corroboration result, (vi) concluding, based on the corroboration result, the first data is corroborated, and/or (vii) other methods. Refer to the description of FIG. 3B for additional details regarding generating the corroborated data.

At operation 304, at least a portion of the corroborated data may be provided to the data consumer to facilitate provisioning of the computer-implemented services. Providing the at least a portion of the corroborated data to the data consumer may include: (i) transmitting the at least a portion of the corroborated data to the data consumer via a message, (ii) providing the at least a portion of the corroborated data to another entity (e.g., an intermediate entity) responsible for providing the at least a portion of the corroborated data to the data consumer, (iii) storing the at least a portion of the corroborated data in a storage with subsequent retrieval by the data consumer, and/or (iv) other methods.

The method may end following operation 304.

Turning to FIG. 3B, a second flow diagram illustrating a method in accordance with an embodiment is shown. The second flow diagram may illustrate various operations performed while corroborating first data to obtain a corroboration result. The operations shown in FIG. 3B may be performed prior to performing operation 300 shown in FIG. 3A (e.g., prior to obtaining a request for corroborated data from a data consumer in order to populate a corroborated data database) and/or may be performed as part of performing operation 302 shown in FIG. 3A (e.g., to generate the corroborated data). The method may be performed, for example, by any of the components of the system of FIG. 1, and/or any other entity without departing from embodiments disclosed herein.

At operation 310, first data to be corroborated, the first data being from a first data source and having a first information content, and the corroboration requirements may be obtained. Obtaining the first data may include: (i) receiving the first data from a data consumer (e.g., as part of a request for corroborated data), (ii) receiving the first data from another entity (e.g., the first data source, a management entity of the first data source, an intermediate entity), (iii) reading the first data from storage (e.g., from a database), and/or (iv) other methods.

At operation 312, it may be determined whether data is available that is usable to corroborate the first data that meets the corroboration requirements. Making the determination may include: (i) performing a lookup process using a lookup table included in a database and a first information content of the first data and/or other metadata for the first data to be corroborated as a key for the lookup table to identify entries including data usable to corroborate the first data, (ii) comparing the data and/or metadata included in the identified entries to the corroboration requirements, (iii) concluding that none of the identified entries meet the corroboration requirements, and/or (iv) other methods. Making the determination may also include providing a request for the data usable to corroborate the first data that meets the corroboration requirements to another entity and receiving a notification indicating that no data is available in response.

Performing the lookup process may include: (i) searching entries in the database to identify entries including data usable to corroborate the first data (e.g., using the first information content as key phrases for the search), (ii) providing the first information content to another entity and receiving the entries including data usable to corroborate the first data in response, and/or (iii) other methods.

If it is determined that no data is available that is usable to corroborate the first data that meets the corroboration requirements (e.g., the determination is “No” at operation 312), then the method may proceed to operation 314.

At operation 314, the corroboration requirements may be relaxed to obtain the relaxed corroboration requirements. Relaxing the corroboration requirements may include: (i) modifying at least a portion of the corroboration requirements to obtain the relaxed requirements which include a lower standard for corroboration compared to the corroboration requirements, (ii) receiving the relaxed corroboration requirements from another entity (e.g., the data consumer), (iii) reading the relaxed corroboration requirements from storage, and/or (iv) other methods.

Modifying at least a portion of the corroboration requirements may include: (i) updating a type of information content of the data (e.g., including a type of information content with a known relationship to the first information content), (ii) extending a timeframe in which the data was collected (e.g., allowing past data to be used to corroborate the first data), (iii) extending a geographic location of the data source (e.g., allowing the data source to be further away than indicated by the corroboration requirements), and/or (iv) other methods. Relaxing the corroboration requirements may also include obtaining relaxed corroboration requirements which retain a portion of the corroboration requirements.

At operation 316, the second data may be obtained based on the relaxed corroboration requirements, the second data meeting the relaxed corroboration requirements and having a second information content. Obtaining the second data may include: (i) performing a lookup process using a lookup table included in a database and a first information content of the first data and/or other metadata for the first data to be corroborated as a key for the lookup table to identify entries including data usable to corroborate the first data, (ii) comparing the data included in the identified entries to the relaxed corroboration requirements, (iii) selecting, from the identified entries, the second data which meets the relaxed corroboration requirements, and/or (iv) other methods. Obtaining the second data may also include providing a request for the second data including the relaxed corroboration requirements to another entity (e.g., an intermediate entity, the second data source, a management entity of the second data source) and receiving the second data in response.

At operation 318, a corroboration process may be performed using at least the first data and the second data and based on the relaxed corroboration requirements to obtain a corroboration result. Performing the corroboration process may include: (i) making a determination regarding whether the first information content substantially matches the second information content, (ii) in a first instance of the determination in which the first information content substantially matches the second information content: concluding that the second data corroborates the first data to obtain the corroborated data, assigning, based on at least the second data and a level of trust schema, a level of trust for the corroborated data, (iii) in a second instance of the determination in which the first information content does not substantially match the second information content: concluding that the second data does not corroborate the first data, and/or (iv) other methods. Refer to the description of FIG. 3C for additional details regarding performing the corroboration process.

At operation 320, it may be concluded, based on the corroboration result, that the first data is corroborated. The corroboration result may include: (i) an indication of whether the first information content substantially matches the second information content, (ii) the level of trust for the corroborated data, (iii) metadata indicating limits on use of the corroborated data, and/or (iv) other information. Concluding that the first data is corroborated may include: (i) reading a portion of the corroboration result indicating that the first information content substantially matches the second information content, (ii) generating a data structure indicating that the first data is corroborated, (ii) storing the data structure in a database and/or other storage architecture for retrieval when determining whether the first data is corroborated, (iii) notifying (e.g., via a message over a communication system, via a graphical user interface (GUI) on a device) another entity (e.g., the data consumer) that the first data is corroborated, and/or (iv) other methods.

The method may end following operation 320.

Returning to operation 312, if it is determined that data is available that is usable to corroborate the first data that meets the corroboration requirements (e.g., the determination is “Yes” at operation 312), then the method may end. The corroboration process may be performed using the data that meets the corroboration requirements.

Turning to FIG. 3C, a third flow diagram illustrating a method in accordance with an embodiment is shown. The third flow diagram may illustrate various operations performed while performing a corroboration process to obtain corroborated data. The operations shown in FIG. 3C may be performed prior to performing operation 300 shown in FIG. 3A (e.g., prior to obtaining a request for corroborated data from a data consumer in order to populate a corroborated data database) and/or may be performed as part of performing operation 302 shown in FIG. 3A (e.g., to generate the corroborated data). The method may be performed, for example, by any of the components of the system of FIG. 1, and/or any other entity without departing from embodiments disclosed herein.

At operation 330, it may be determined whether the first information content of the first data substantially matches the second information content of the second data. Making the determination may include: (i) comparing the first information content to the second information content to obtain a difference, (ii) making a determination regarding whether the difference meets criteria to be considered substantially matching, and/or (iii) other methods. The difference may indicate a degree to which the second information content corroborates the first information content.

Comparing the first information content to the second information content may include performing any number and/or type of similarity analysis processes to obtain the difference. In a first example, comparing the first information content to the second information content may include: (i) obtaining a first quantity from the first information content, (ii) obtaining a second quantity from the second information content, and/or (iii) performing a statistical analysis (e.g., analysis of variance (ANOVA), regression, hypothesis testing) to obtain the difference. In a second example, comparing the first information content to the second information content may include: (i) providing the first information content and the second information content to an inference model and ingest, (ii) prompting the inference model to compare the first information content and the second information content (e.g., providing the inference model a prompt, the prompt including instructions for the inference model to compare the first information content and the second information content), and/or (iii) obtaining an output from the inference model, the output being usable to obtain the difference.

Making the determination regarding whether the difference meets criteria to be considered substantially matching may include: (i) obtaining the criteria (e.g., from a SME, data consumer, and/or any other entity), (ii) comparing a quantity of the difference to a corresponding quantity of the criteria, and/or (iii) other methods. Determining whether the difference meets the criteria may also include providing the difference and the criteria to another entity responsible for comparing the difference to the criteria.

Obtaining the criteria may include: (i) reading the criteria from storage, (ii) receiving the criteria from another entity (e.g., the data consumer, the SME), (iii) generating the criteria, and/or (iv) other methods. The criteria may include any criteria for substantially matching. For example, the criteria may: (i) permit a 10% difference (e.g., at least 90% of the first information content and the second information content matches), (ii) permit a 5% difference (e.g., at least 95% of the first information content and the second information content matches), (iii) permit a 2% difference (e.g., at least 98% of the first information content and the second information content matches), and/or (iv) include other criteria to be considered substantially matching.

If it is determined that the first information content substantially matches the second information content (e.g., the determination is “Yes” at operation 330), then the method may proceed to operation 332.

At operation 332, it may be concluded that the second data corroborates the first data to obtain the corroborated data. Concluding that the second data corroborates the first data may include: (i) generating a data structure indicating that the second data corroborates the first data, (ii) signing the data structure using a private key of a trusted entity, the private key being part of a public private key pair usable to cryptographically verify that the entity which generated the data structure is the trusted entity, (iii) storing the data structure in a corroborated data database, and/or (iv) other methods.

At operation 334, a level of trust may be assigned for the corroborated data based on at least the second data and a level of trust schema. Assigning the level of trust may include: (i) obtaining the level of trust schema (e.g., reading the level of trust schema from storage, receiving the level of trust schema from another entity, generating the level of trust schema), (ii) obtaining a degree of corroboration for the corroborated data, (iii) using the degree of corroboration to search the level of trust schema for the level of trust associated with the degree of corroboration, and/or (iv) other methods.

Obtaining the degree of corroboration for the corroborated data may include (i) reading the degree of corroboration from storage, (ii) assigning the corroborated data the degree of corroboration based on a quantity of data sources which corroborate the data and/or based on a quantity of aspects of the data which are corroborated, (iii) providing the corroborated data to another entity and receiving the degree of corroboration in response, and/or (iv) other methods. Aspects of the data may include: (i) a portion of a third information content of the data (and/or any number of other information contents for the data), (ii) a timestamp for the data, (iii) a geographic location where the data was collected, and/or (iv) other information.

Assigning the corroborated data the degree of corroboration may include: (i) obtaining the quantity of data sources which corroborate the data, the quantity of aspects of the data which are corroborated, and/or other information usable to assign the degree of corroboration, (ii) performing a lookup process using the quantity of data sources which corroborate the data and/or the quantity of aspects of the data which are corroborated as a key for a degree of corroboration table (e.g., a lookup table), (iii) obtaining, as a result of the lookup process and from the degree of corroboration table, the degree of corroboration for the data, (iv) using the quantity of data sources which corroborate the data and/or the quantity of aspects of the data which are corroborated as the degree of corroboration, (v) calculating, using any formula and/or rule set for calculating degrees of corroboration, the degree of corroboration based on the quantity of data sources which corroborate the data, the quantity of aspects of the data which are corroborated, and/or the other information, and/or (vi) other methods.

Using the degree of corroboration to search the level of trust schema for the level of trust associated with the degree of corroboration may include: (i) performing a lookup process using the degree of corroboration as a key for the level of trust schema, (ii) obtaining, as a result of the lookup process from the level of trust schema, the level of trust, (iii) providing the degree of corroboration and/or the level of trust schema to another entity and receiving the level of trust in response, and/or (iv) other methods.

The method may end following operation 334.

Returning to operation 330, if it is determined that the first information content does not substantially match the second information content (e.g., the determination is “No” at operation 316), then the method may proceed to operation 336.

At operation 336, it may be concluded that the second data does not corroborate the first data. Concluding that the second data does not corroborate the first data may include: (i) generating a data structure indicating that the second data does not corroborate the first data, (ii) storing the data structure in a database and/or other storage architecture, (iii) notifying (e.g., via a message over a communication system, via a graphical user interface (GUI) on a device) another entity (e.g., the first data source, a management entity of the first data source) that the second data does not corroborate the first data, and/or (iv) other methods.

If the second data does not corroborate the first data, data from additional data sources may be evaluated to determine whether any of the data from the additional data sources corroborate the first data. Determining whether any of the data from the additional data sources corroborate the first data may include methods similar to those described in operations 312-320.

The method may end following operation 336.

Thus, as illustrated above, embodiments disclosed herein may provide systems and methods usable to obtain corroborated data used to facilitate provisioning of computer-implemented services. By performing a corroboration process using relaxed corroboration requirements, a likelihood of obtaining the corroborated data may be increased. The corroborated data may then be provided to a data consumer in a manner which meets the expectations of the data consumer. By doing so, a likelihood of providing the computer-implemented services as desired may be increased.

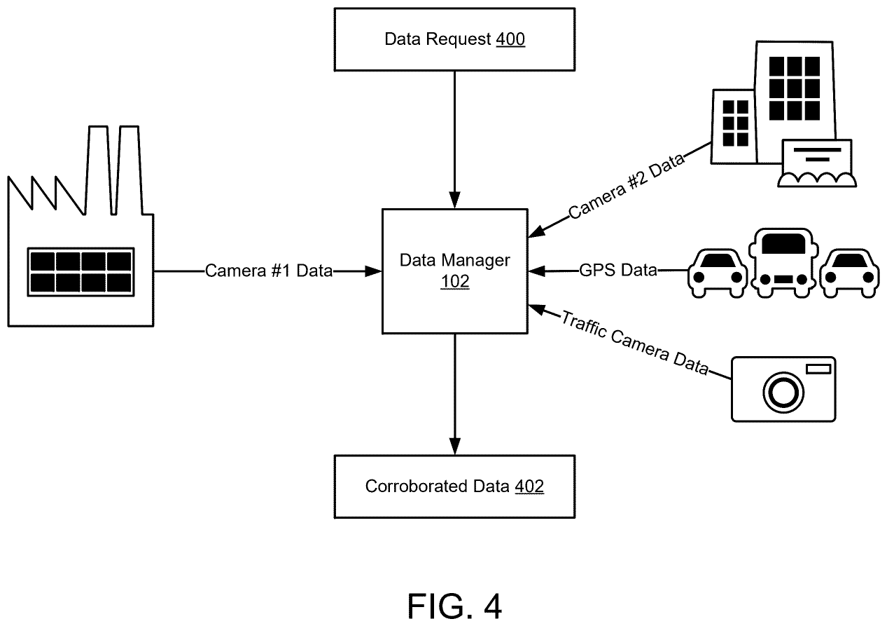

To further clarify embodiments disclosed herein, an example implementation in accordance with an embodiment is shown in FIG. 4. Turning to FIG. 4, a diagram illustrating an example of providing corroborated data (e.g., corroborated data 402) to a data consumer upon obtaining a request for the corroborated data (e.g., data request 400) is shown.

Consider a scenario in which data manager 102 manages security data for a factory. As part of managing the security data, data manager 102 may obtain data from any number of data sources, store data, corroborate data, and/or provide corroborated data to a security data consumer upon obtaining a request for the corroborated data.

For example, data manager 102 may obtain first security camera data including video of the factory entrance (e.g., camera #1 data). Upon obtaining a request for corroborated data from the security data consumer, data manager 102 may corroborate the camera #1 data. To do so, data manager 102 may obtain other data from other data sources, which may include: (i) video of the factory entrance obtained by a second security camera positioned on a building across the street (e.g., camera #2 data), (ii) location data obtained by smart car GPS systems from cars parked in the factory parking lot (e.g., GPS data), and/or (iii) images of the factory entrance obtained by a traffic camera (e.g., traffic camera data). The other data sources may be owned, operated, and/or otherwise managed by entities which do not manage the first security camera (e.g., the other data sources may not be in the same sphere of trust as the first security camera).

To corroborate the camera #1 data, data manager 102 may perform a corroboration process using corroboration requirements included in the request to compare a first information content from the camera #1 data to an information content from each of the other data from the other data sources. For example, the first information content may include a number of people who entered the factory on April 28^{th} measured by the first security camera (e.g., 127 people).

The corroboration requirements may include a requirement to corroborate the camera #1 data using the traffic camera data. However, the traffic camera may be unable to provide data usable to corroborate the camera #1 data (e.g., due to being powered off on April 28^{th}). As a result, at least a portion of the corroboration requirements may be unable to be met.

To corroborate the camera #1 data, data manager 102 may relax the corroboration requirements to obtain relaxed corroboration requirements. The relaxed corroboration requirements may include allowing data from other data sources, such as the camera #2 data and the GPS data, to be used to corroborate the camera #1 data.

To corroborate the camera #1 data using the camera #2 data, the first information content may be compared to a second information content of the camera #2 data, which may include a number of people who entered the factory on April 28^{th} measured by the second security camera (e.g., 128 people). During the corroboration process, data manager 102 may use criteria for substantially matching to determine that the first information content substantially matches the second information content and, thus, it may be concluded that the camera #2 data corroborates the camera #1 data.

A similar corroboration process may be performed using the GPS data. Data manager 102 may conclude that data from the second security camera and the smart car GPS systems (e.g., two data sources) corroborates the camera #1 data. Based on the quantity of data sources which corroborates the camera #1 data and a level of trust schema, data manager 102 may assign the camera #1 data a level of trust of 3 (e.g., on a scale of 1-10, with 1 being the lowest level of trust and 10 being the highest level of trust). The camera #1 data may then be provided to the data consumer.

Any of the components illustrated in FIGS. 1-4 may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein.

Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory.

Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD).

However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing data used to provide computer-implemented services, the method comprising:
obtaining a request for corroborated data from a data consumer, the request indicating a desired information content and corroboration requirements for the corroborated data;
obtaining, based on the request, the corroborated data, the corroborated data:
having the desired information content and being obtained by a first data source and being corroborated using at least second data obtained by a second data source, the second data source being adapted to measure a similar information content to the desired information content which the first data source is adapted to measure;
being corroborated using relaxed corroboration requirements due to at least a portion of the corroboration requirements being unable to be met, the relaxed corroboration requirements being acceptable to the data consumer; and
providing at least a portion of the corroborated data to the data consumer to facilitate provisioning of the computer-implemented services.

2. The method of claim 1, wherein the relaxed corroboration requirements comprise a lower standard for corroboration compared to the corroboration requirements.

3. The method of claim 1, wherein the corroboration requirements comprise at least one type of requirement selected from a list of types of requirements consisting of:
a type of information content of the second data;
a timeframe in which the second data was generated; and
a geographic location of the second data source.

4. The method of claim 1, wherein the request for corroborated data indicates an urgency of need for the corroborated data.

5. The method of claim 1, further comprising:
obtaining first data from the first data source to be corroborated and the corroboration requirements, the first data having a first information content;
making a determination that no data is available that is usable to corroborate the first data that meets the corroboration requirements;
based on the determination:
relaxing the corroboration requirements to obtain the relaxed corroboration requirements;
obtaining, based on the relaxed corroboration requirements, the second data, the second data meeting the relaxed corroboration requirements and having a second information content;
performing, using at least the first data and the second data, and based on the relaxed corroboration requirements, a corroboration process to obtain a corroboration result; and
concluding, based on the corroboration result, the first data is corroborated.

6. The method of claim 5, wherein performing the corroboration process comprises:
making a determination regarding whether the first information content substantially matches the second information content;
in a first instance of the determination in which the first information content substantially matches the second information content:
concluding that the second data corroborates the first data to obtain the corroborated data;
assigning, based on at least the second data and a level of trust schema, a level of trust for the corroborated data; and
in a second instance of the determination in which the first information content does not substantially match the second information content:
concluding that the second data does not corroborate the first data.

7. The method of claim 6, wherein the corroboration result comprises an indication of whether the first information content substantially matches the second information content, the level of trust for the corroborated data, and metadata indicating limits on use of the corroborated data.

8. The method of claim 6, wherein the level of trust schema comprises a rule set for assigning levels of trust to data based on degrees of corroboration of the data.

9. The method of claim 8, wherein the degrees of corroboration are based on a quantity of aspects of the data which are corroborated.

10. The method of claim 9, wherein the aspects comprise at least one type of aspect selected from a list of types of aspects consisting of:
a portion of a third information content of the data;
a timestamp for the data; and
a geographic location where the data was collected.

11. The method of claim 8, wherein the degrees of corroboration are based on a quantity of data sources which corroborate the data, and the rule set ascribes higher levels of trust with higher degrees of corroboration.

12. The method of claim 5, wherein the corroboration requirements indicate that the data usable to corroborate the first data is only available from data sources that are unable to provide the data at a time of corroboration of the corroborated data, and the second data source does not meet the corroboration requirements.

13. The method of claim 1, wherein the corroborated data is deemed to be corroborated based on the second data source:
having provided an information content of data generated by the second data source substantially matching the desired information content; and
not supplying synthetic data.

14. The method of claim 1, wherein the corroborated data is not synthetic data.

15. A non-transitory machine-readable medium having instructions stored therein, which when executed by a processor, cause the processor to perform operations for managing data used to provide computer-implemented services, the operations comprising:
obtaining a request for corroborated data from a data consumer, the request indicating a desired information content and corroboration requirements for the corroborated data;
obtaining, based on the request, the corroborated data, the corroborated data:
having the desired information content and being obtained by a first data source and being corroborated using at least second data obtained by a second data source, the second data source being adapted to measure a similar information content to the desired information content which the first data source is adapted to measure;
being corroborated using relaxed corroboration requirements due to at least a portion of the corroboration requirements being unable to be met, the relaxed corroboration requirements being acceptable to the data consumer; and
providing at least a portion of the corroborated data to the data consumer to facilitate provisioning of the computer-implemented services.

16. The non-transitory machine-readable medium of claim 15, wherein the relaxed corroboration requirements comprise a lower standard for corroboration compared to the corroboration requirements.

17. The non-transitory machine-readable medium of claim 15, wherein the corroboration requirements comprise at least one type of requirement selected from a list of types of requirements consisting of:
a type of information content of the second data;
a timeframe in which the second data was generated; and
a geographic location of the second data source.

18. A data processing system, comprising:
a processor; and
a memory coupled to the processor to store instructions, which when executed by the processor, cause the processor to perform operations for managing data used to provide computer-implemented services, the operations comprising:
obtaining a request for corroborated data from a data consumer, the request indicating a desired information content and corroboration requirements for the corroborated data;
obtaining, based on the request, the corroborated data, the corroborated data:
having the desired information content and being obtained by a first data source and being corroborated using at least second data obtained by a second data source, the second data source being adapted to measure a similar information content to the desired information content which the first data source is adapted to measure;
being corroborated using relaxed corroboration requirements due to at least a portion of the corroboration requirements being unable to be met, the relaxed corroboration requirements being acceptable to the data consumer; and
providing at least a portion of the corroborated data to the data consumer to facilitate provisioning of the computer-implemented services.

19. The data processing system of claim 18, wherein the relaxed corroboration requirements comprise a lower standard for corroboration compared to the corroboration requirements.

20. The data processing system of claim 18, wherein the corroboration requirements comprise at least one type of requirement selected from a list of types of requirements consisting of:
a type of information content of the second data;
a timeframe in which the second data was generated; and
a geographic location of the second data source.
